(19) United States
(12) Patent Application Publication
(10) Pub. No.: US 2021/0365789 A1
(43) Pub. Date: Nov. 25, 2021

(54) METHOD AND SYSTEM FOR TRAINING MACHINE LEARNING SYSTEM

(71) Applicant: Sony Corporation, Tokyo (JP)

(72) Inventor: Jim RASMUSSON, Lund (SE)

(21) Appl. No.: 17/051,252

(22) PCT Filed: May 10, 2018
(86) PCT No.: PCT/US2018/032065

§ 371 Date: Oct. 28, 2020

(51) Int. Cl. G06N 3/08; G06N 3/04

(52) U.S. Cl. CPC G06N 3/084; G06N 3/04

(57) ABSTRACT

Embodiments generally relate to training systems and methods for machine learning systems. In one embodiment the training method permits selected portions of a set of training images to be segregated by a boundary so that training image patterns in the set of training images and within the boundaries can be presented for the training while portions outside of the boundaries can be deemphasized or otherwise obscured for the training. A smooth continuous de-emphasis gradient is exercised at the boundary between the presented and the deemphasized or obscured portions of the training images.

### TECHNICAL FIELD OF THE INVENTION

The embodiments of the present disclosure generally relate to the field of training machine learning systems, particularly to training deep learning networks, and more particularly to a method, system and computer readable medium storing instructions that, when executed by a processor, train supervised deep learning networks by pre-processing a set of training images using soft emphasis of relevant objects in the set of training to images and then using the pre-processed training images to train the deep learning networks.

### BACKGROUND

Machine learning systems are trainable to perform complicated tasks seemingly naturally such as for example voice recognition, image recognition, and character recognition. In the field of character recognition, images representing characters from an alphabet are recognized and the character from this alphabet is generated in response to input representations of those characters. Similarly, in the fields of voice and image recognition, digitized sound recordings representing voices and digitized images representing image patterns are recognized, and the voice or image patterns identified from this data are generated in response to the inputted representations of those data types.

Once trained, these systems perform tasks in a human-like fashion and in environments that might be too harsh for human workers or impractical due to other constraints. Robots can be trained to recognize characters, voices and images for performing tasks such as recognizing printed forms for routing postal items, performing voice actuated commands, and assembling various components on a manufacturing process line. Machine learning systems find application in diverse fields of application ranging from consumer goods to medical devices and systems, to robotic manufacturing.

These systems learn by example wherein both input data and desired output data are provided in pairs. Input and output data are labelled for classification to provide a learning basis for future data processing. Supervised deep learning networks of the type described herein by way of example are trained to recognize patterns in the input data presented to the network during one or more training sessions. In deep learning image networks, training images of a target pattern, such as training images having rose target patterns for example, are sent to the input nodes of the deep learning network one by one. Middle nodes in one or more intermediate layer(s) within the learning network process the input data and output nodes generate an identification output. Errors in the output nodes of the network are back-propagated through the middle nodes whereat intra-network node weighting and/or other parameters may be updated to reflect the error. This process is repeated iteratively until the training is deemed to be “completed” such as when, for example, selected one or more error metrics plateau or otherwise “level off” at which point the network being trained realizes no further significant learning or accuracy improvements.

Given the above, preferably, sufficient training data should be provided from a diverse enough range of the target patterns; roses in the example, to adequately train the network.

As would be appreciated, the set of training images received at the inputs of the deep learning network oftentimes contains data representative not only of the desired training image patterns, but also of extraneous image data representative of one or more extraneous image patterns in the training image set. This extraneous image data representative of the one or more extraneous image patterns in the training image set is not useful for the training but, rather, adds a degree of difficulty to the training process.

As a general rule of thumb more training images are better than less training images for ensuring the robustness of the trained deep learning network. This is especially true when the training images are busy with extraneous information extending beyond the desired training image patterns. By way of example, the training image patterns containing images of roses may also contain images of other background, soil, grass, old yellow plants, or the like. A very large training set is desired in these situations.

Some attempts to train deep learning networks with a limited set of training images busy with patterns other than the training patterns have met with failure.

One proposed solution is to segregate or otherwise isolate portions of the training images that contain the training image patterns from other portions of the training images having extraneous image patterns that are not necessarily relevant to the training image patterns. Obliterating the portions of the training images having the extraneous image patterns or other miscellaneous information such as by whiting-out or blackening-out those portions indeed works to segregate or otherwise isolate portions of the training images that contain the relevant training image patterns. However, the technique of this solution has severe side effects because the demarcation in the training images that are used to separate the relevant from the non-relevant portions of the training image is itself interpreted by the network being trained as useful information. This confounds the deep learning training protocol as the learning network essentially trains on the edge of the boundary.

### SUMMARY

In the following, an overview of the present invention is given simply to provide basic understanding to some aspects of the present invention. It should be understood that this overview is not an exhaustive overview of the present invention. It is not intended to determine a critical part or an important part of the present invention, nor to limit the scope of the present invention. An object of the overview is only to give some concepts in a simplified manner, which serves as a preface of a more detailed description described later.

Embodiments generally relate to machine learning systems training systems, methods for training machine learning systems, and computer readable medium storing instructions thereon that when executed by a processor perform steps for training machine learning systems. In one embodiment the training method permits selected portions of a set of training images to be segregated by a boundary so that training image patterns in the set of training images and within the boundaries can be presented for the training without de-emphasis or de-rating, while portions outside of the boundaries can be deemphasized or otherwise obscured for the training.

In one example, a de-rating value or level is applied to portions of the training data outside of the boundaries so that this portion of the training data may be deemphasized or otherwise obscured for the training. As a particular example, a gradual or soft change such as a decrease of image or pixel values towards lower values or even black, wherein black may be defined when the pixel values are all zero (0), may be used to deemphasize or otherwise obscure the second portion of the training images from the training of the deep learning network. As a further particular example, a gradual or soft change such as a gradual blending of noise from original pixel values of the training images to noise-added-pixel values may be used to deemphasize or otherwise obscure the second portion of the training images from the training of the deep learning network. As still yet a further particular example, a gradual or soft change such as a gradual blurring of the original pixel values of the training images to blurred versions of the pixel values may be used to deemphasize or otherwise obscure the second portion of the training images from the training of the deep learning network.

As yet a further particular example, a gradual or soft change such as a decrease of image or pixel values towards lower values or even black (black is when the pixel values are all 0) in combination with a gradual blending of noise from original pixel values of the training images to noise-added-pixel values may be used to deemphasize or otherwise obscure the second portion of the training images from the training of the deep learning network.

As yet a still further particular example, a gradual or soft change such as a gradual blending of noise from original pixel values of the training images to noise-added-pixel values in combination with a gradual or soft change such as a gradual blurring of the original pixel values of the training images to blurred versions of the pixel values may be used to deemphasize or otherwise obscure the second portion of the training images from the training of the deep learning network.

As still a yet further particular example, a gradual or soft change such as a decrease of image or pixel values towards lower values or even black (black is when the pixel values are all 0) in combination with a gradual blending of noise from original pixel values of the training images to noise-added-pixel values in combination with a gradual or soft change such as a gradual blurring of the original pixel values of the training images to blurred versions of the pixel values may be used to deemphasize or otherwise obscure the second portion of the training images from the training of the deep learning network.

The de-rating value or level is applied in the example embodiments to form soft-emphasized training data by a gradual application of the de-rating level to the second portion of the training data from a foregoing of the application of the de-rating level at the boundary between the first and second portions of the training data, and by an increasing application of the de-rating value or level to the second portion of the training data from the boundary outwardly from the selected closed shape. This helps to reduce the side effects owing to the demarcation in the training images at the boundary that is used to separate the relevant from the non-relevant portions of the training image so that the boundary itself is not interpreted by the network being trained as useful training information.

In an example embodiment, the gradual application of the de-rating level to the second portion of the training data is linear.

In another example embodiment, the gradual application of the de-rating level to the second portion of the training data follows a logistic function. In this embodiment, the logistic function allows for a smooth transition from an absence of application of the de-rating level at the boundary between the first and second portions of the training images to a full application of the de-rating level outwardly of the boundary. Further in this embodiment, the slope of the de-rating level application function does not change abruptly moving from the first portion of the training data (de-rating level not applied) to the second portion of the training data (initially no de-rating level applied followed by full de-rating level applied).

Overall therefore, a smooth continuous de-emphasis is exercised at the boundary between the presented and the deemphasized or obscured portions of the training images.

In an embodiment, a method of training a deep learning network is provided. Training data representative of a training image is received at a first input of a training station. Isolation data is received at a second input of the training station. The isolation data is representative of a selected closed shape segregating the training data into a first portion within a boundary defined by the closed shape and a second portion outside of the boundary. De-emphasis data is received at a third input of the training station. The de-emphasis data is representative of a de-rating level to be applied to the second portion of the training data.

The de-rating level is applied to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape.

An output signal is generated at a first output of the training station. The output signal is representative of the soft-emphasized training data for training an associated deep learning network to recognize a pattern in the training data.

Learning data is received at a fourth input of the training station from the associated deep learning network. The learning data is representative of a learned pattern learned by the associated deep learning network responsive to the output signal generated at the first output of the training station.

The training station determines an error based on a comparison between target pattern data representative of a training target pattern contained in the training data and the learning data representative of the learned pattern learned by the associated deep learning network, and generates an error output signal at a second output of the training station. The error output signal is representative of the determined error for back-propagating the error by the associated deep learning network for the training.

In yet another embodiment, a method is provided for training an associated deep learning network to recognize a target pattern using pre-processed training images.

The method receives first training data at a first input of a training station operatively coupled with the associated deep learning network. The first training data is representative of a first training image and comprises first training image data representative of a first training image pattern in the first training image, and first extraneous image data representative of one or more first extraneous image patterns in the first training image.

The training image is divided into first and second portions by a boundary. First isolation data is received at a second input of the training station. The first isolation data is representative of a selected closed shape defining a boundary dividing the first training data into first and second portions. The first portion of the first training data comprises the first training image data representative of the first training image pattern and is segregated from the second portion of the first training data by the selected closed shape. The second portion of the first training data is segregated from the first portion of the first training data by the selected closed shape.

De-emphasis data is received at a third input of the training station. The first de-emphasis data is representative of a first de-rating level to be applied to one or more selected portions of the first training data.

The first de-rating level is applied to the first training data to form soft-emphasized training data by applying the first de-rating level to the first training data in accordance with: a full application of the de-rating level to the second portion of the first training data thereby reducing effects of the first extraneous image data in the soft-emphasized training data; a foregoing of the application of the de-rating level to the first portion of the first training data thereby preserving the first training image data representative of the first training image pattern in the soft-emphasized training data; and a smooth continuous gradient of the application of the de-rating level to the boundary dividing the first training data into the first and second portions.

The learning network is trained using the pre-processed training data images. The soft-emphasized training data is delivered by the training station to an input of the associated deep learning network. The training station receives from an output of the associated deep learning network, first learning data representative of a first learned pattern learned by the associated deep learning network responsive to the associated deep learning network receiving the soft-emphasized training data. The training station determines an error based on a comparison between target pattern data representative of the target pattern and the first learning data representative of the first learned pattern learned by the associated deep learning network. The error is backpropagated by the training station to nodes of the associated deep learning network to effect the training.

### BRIEF DESCRIPTION OF THE DRAWINGS

To further set forth the above and other advantages and features of the present invention, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present invention and should not be construed as a limitation to the scope of the invention. In the accompanying drawings:

FIG. 1 illustrates a functional structure block diagram of a training station for training an associated learning network by pre-processing training images and training the associated learning network using the pre-processed training images in accordance with an embodiment of the present disclosure;

FIG. 2 is a schematic block diagram of a training station for training an associated learning network in accordance with an embodiment of the present disclosure;

FIG. 3 is a block diagram of selected control logic modules executed by the training station of FIG. 2;

FIG. 4 illustrates an example of a first training image in accordance with an embodiment of the present disclosure;

FIG. 5 illustrates an example of a selected closed shape applied to the first training image of FIG. 4 accordance with an embodiment of the present disclosure;

FIGS. 6a-6c illustrate examples of selected closed shapes available for application to the first training image of FIG. 4 accordance with further embodiments of the present disclosure;

FIG. 7a is an illustration of a conceptual cross-section taken through line 7a-7a of FIG. 5 showing a de-rating level being applied linearly to the first training data in accordance with the example embodiment;

FIG. 7b is an illustration of resultant continuous gradients of the linear application of the de-rating level at left and right boundaries dividing the first training data into the first and second portions;

FIG. 7c is an illustration of a conceptual cross-section taken through line 7c-7c of FIG. 5 showing a de-rating level being non-linearly applied to the first training data in accordance with the example embodiment;

FIG. 7d is an illustration of resultant smooth continuous gradients of the non-linear application of the de-rating level at left and right boundaries dividing the first training data into the first and second portions;

FIG. 8a is an illustration of a conceptual cross-section taken through line 8a-8a of FIG. 5 showing a de-rating level being applied to the first training data in accordance with the prior art;

FIG. 8b is an illustration of resultant discontinuous pulse type gradients of the application of the de-rating level at left and right boundaries dividing the first training data into the first and second portions;

FIG. 9 illustrates an example of a selected closed shape having a user-defined width applied to the first training image of FIG. 4 accordance with a further example embodiment of the present disclosure;

FIG. 10a is an illustration of a conceptual cross-section taken through line 10a-10a of FIG. 9 showing a de-rating level being applied to the first training data by non-linearly increasing the application of the de-rating level to the second portion of the training data from the boundary outwardly from the selected closed shape in accordance with a logistic function in accordance with the example embodiment;

FIG. 10b is an illustration of resultant smooth continuous gradients of the application of the de-rating level at left and right boundaries dividing the first training data into the first and second portions;

FIG. 10c is an illustration of a conceptual cross-section taken through line 10a-10a of FIG. 9 showing a de-rating level being applied to the first training data by linearly increasing the application of the de-rating level to the second portion of the training data from the boundary outwardly from the selected closed shape;

FIG. 11 illustrates a flowchart of a method for training an associated learning network using pre-processed training images in accordance with an example embodiment.

### DETAILED DESCRIPTION OF THE EMBODIMENTS

An exemplary embodiment of the present invention will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present invention due to unnecessary details, only a device structure and/or processing steps closely related to the solution according to the present invention are illustrated in the accompanying drawings, and other details having little relationship to the present invention are omitted.

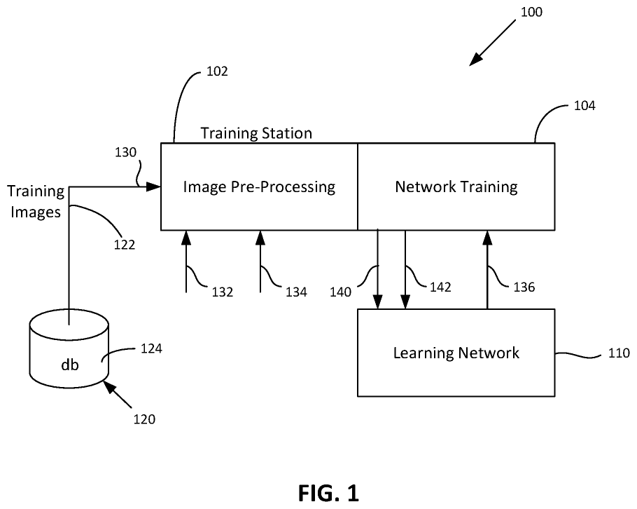

FIG. 1 illustrates a functional structure block diagram of a training station 100 for training an associated learning network 110 by pre-processing training images 122 obtained from an associated storage 120 of plural training images such as for example a training image database 124. A pre-processing portion 102 of the training station 100 preprocesses the training images 122 in accordance with novel pre-processing techniques to be described in greater detail below, and a network training portion 104 of the training station 100 trains the associated learning network 120 using the training images after they are pre-processed in accordance with an embodiment of the present disclosure.

In one embodiment the training method permits selected portions of a set of training images to be segregated by a boundary so that training image patterns in the set of training images and within the boundaries can be presented for the training while portions outside of the boundaries can be deemphasized or otherwise obscured for the training. This helps to limit the impact of the portions of the set of training images outside of the boundaries on the training process overall, thereby increasing the efficiency of the training, which is particularly helpful when attempting to train deep learning networks with a limited set of training images busy with patterns other than the training patterns. In addition and in accordance with the example embodiment, a smooth continuous de-emphasis gradient is exercised at the boundary between the presented and the deemphasized or obscured portions of the training images. Embodiments of the training method described herein have been used on a set of 1,000 training images of weeds resulting in an increased training efficiency of 1-4% over use of the same set of training images but without the masking or de-emphasis techniques of the embodiments herein.

The associated learning network described herein may be a neural network and further may include various neural networks such as a convolutional neural network (CNN), a recurrent neural network, a recursive neural network, a deep learning neural network, and the like. Hereinafter, the deep learning neural network is taken as an example for description, and it should be understood that the present disclosure is not limited thereto.

In accordance with an example embodiment, a deep learning network is trained using the training station 100 shown in the Figure. Training data representative of a training image is received at a first input 130 of the image pre-processing portion 102 of the training station 100. The training images 122 may be obtained from the associated storage 120 of plural training images such as for example the training image database 124.

Isolation data is received at a second input 132 of the image pre-processing portion 102 of the training station 100. In the example embodiment, the isolation data is as will be described below in greater detail representative of a selected closed shape segregating the training data into a first portion within a boundary defined by the closed shape and a second portion outside of the boundary.

De-emphasis data is received at a third input 134 of the image pre-processing portion 102 of the training station. The de-emphasis data is representative of a de-rating level to be applied to the second portion of the training data. As will be described in greater detail below, the de-rating level is applied by a processor of the image pre-processing portion 102 of the training station to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape.

An output signal is generated at a first output 140 of the network training portion 104 of the training station 100. The output signal is representative of the soft-emphasized training data for training an associated deep learning network 110 to recognize a pattern in the training data.

Learning data is received at a fourth input 136 of the training station at the network training portion 104 thereof from the associated deep learning network 110. The learning data is representative of a learned pattern learned by the associated deep learning network responsive to the output signal generated at the first output of the training station. As will be described in greater detail below, a processor of the network training portion 104 of the training station 100 determines an error based on a comparison between target pattern data representative of a training target pattern contained in the training data and the learning data representative of the learned pattern learned by the associated deep learning network 110.

An error output signal is generated at a second output 142 of the network training portion 104 of the training station. In accordance with the example embodiment, the error output signal is representative of the determined error for back-propagating the error by the associated deep learning network for the training.

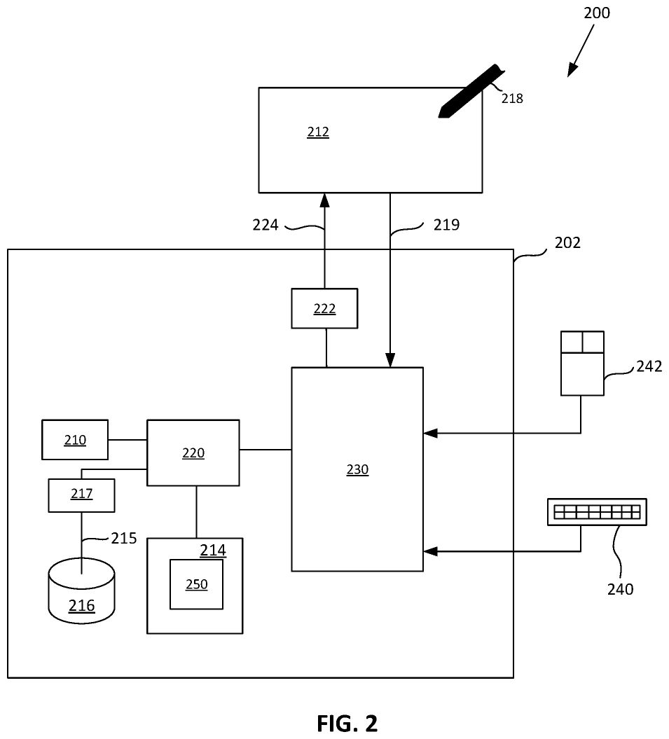

FIG. 2 is a schematic block diagram of a training station 200 for training an associated learning network 210 in accordance with an embodiment of the present disclosure. In FIG. 2 the associated learning network 210 is illustrated as being within the chassis 202 of the training station 200 for ease of reference and description but, as would be appreciated, the associated learning network 210 may be separate from within the chassis 202 of the training station 200, wherein the training station 200 and the associated learning network 210 may be mutually operatively connected by any suitable intermediate network including for example, the Internet. The training station 200 is shown in the schematic block diagram to comprise a data processor 220, a visual display unit 212, a local memory device 214, a large data store 216, and a drawing tool 218. In the embodiment illustrated, the large data store 216 is used to store training data to be retrieved by the training station 200 for pre-processing in ways to be described in greater detail below and for application of the pre-processed training data to the associated learning network 210. It is to be appreciated that, like the associated learning network 210, the large data store 216 is illustrated as being within the training station 200 for ease of reference and description but it may also be separate from the training station 200, wherein the training station 200 and the large data store 216 may be mutually operatively connected by any suitable intermediate network including for example, the Internet.

The visual display unit 212 is connected to an interface processor 230 by a visual display unit (VDU) driving processor 222 within the training station 200 via a connecting channel 224. The drawing tool 218 is similarly connected to the interface processor 230 within the training station 200 via a conductor 219. Also connected to the interface processor 230 is a keyboard 240 and a computer mouse 242. The large data store 216 is connected to a data store access processor 217 via a conductor 215. The VDU graphics driver 222, the interface processor 230 and the data store access processor 217 are all operatively coupled with the processing unit 220 within the training station 200. The local memory device 214 stores logic comprising program code, program instructions, or the like that, when executed by the data processor 220 cause the training station 200 to perform steps for preprocessing the training data stored in the large data store 216, and to apply the pre-processed training data to the associated learning network 210 for training the learning network, all in accordance with the embodiments of the claimed invention herein.

The data processor 220 executes training station logic 250 stored in the memory device 214 for controlling the operation of the training station 200 in accordance with the example embodiments described herein. Users of the training station 200 may use one or more of the pen drawing tool 218, the keyboard 240, and/or the computer mouse 242, all operatively coupled by the interface processor 230 with the processor 220 executing the logic stored in the memory device 214, to interface with the training station to pre-process the training data and to apply the training data to the associated learning network for training it with the pre-processed training images.

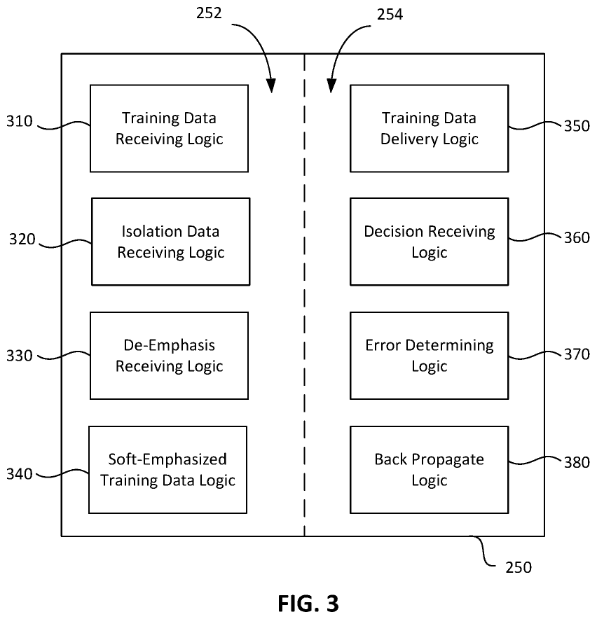

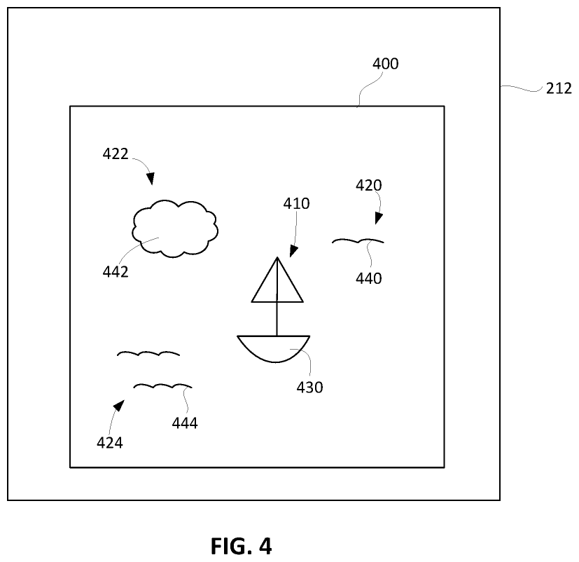

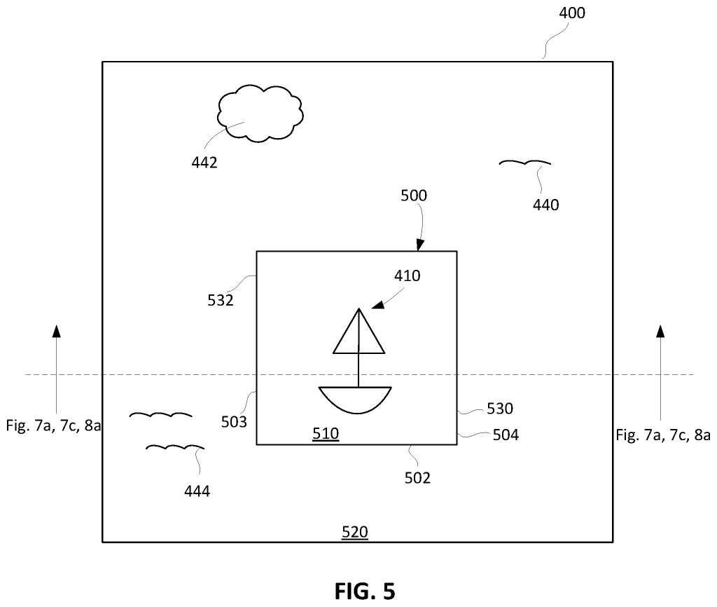

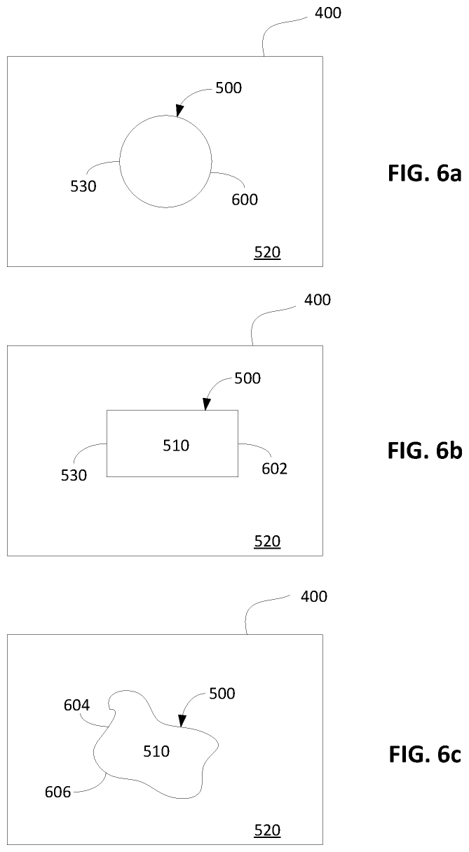

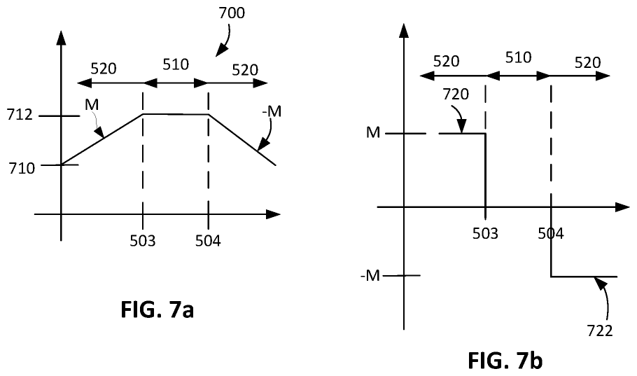

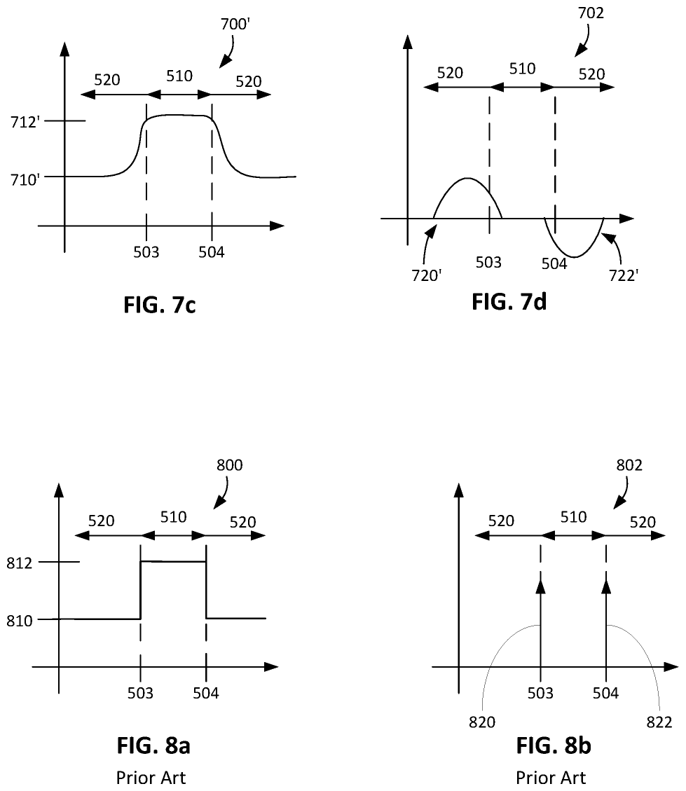

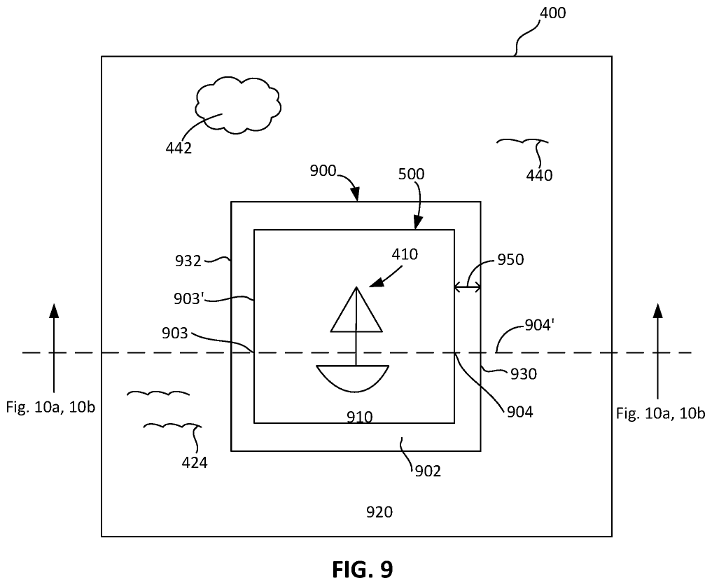

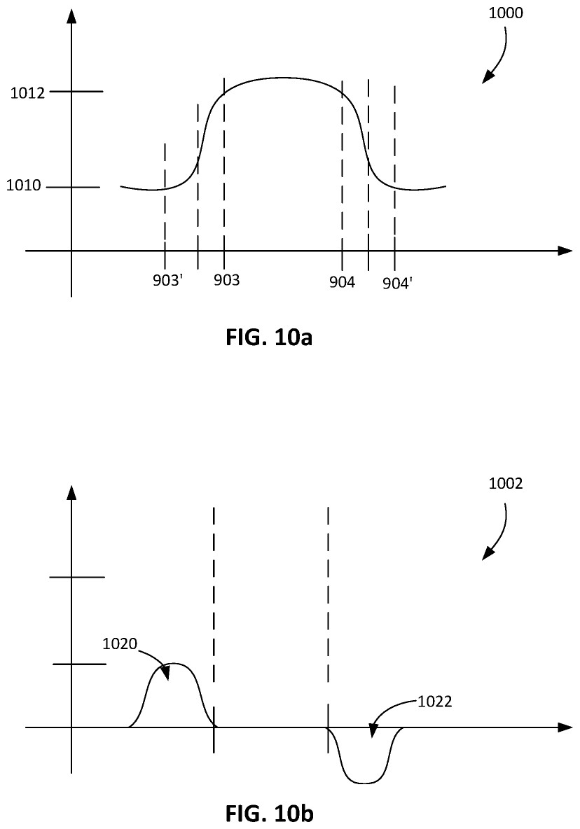

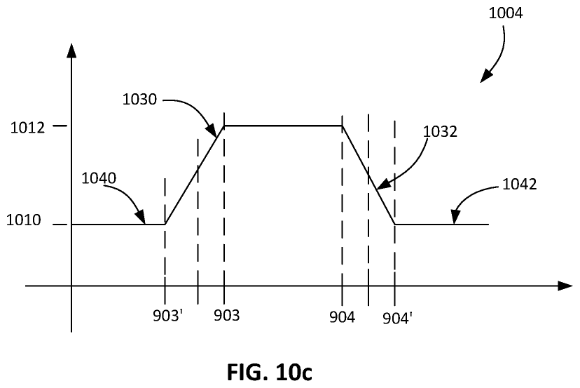

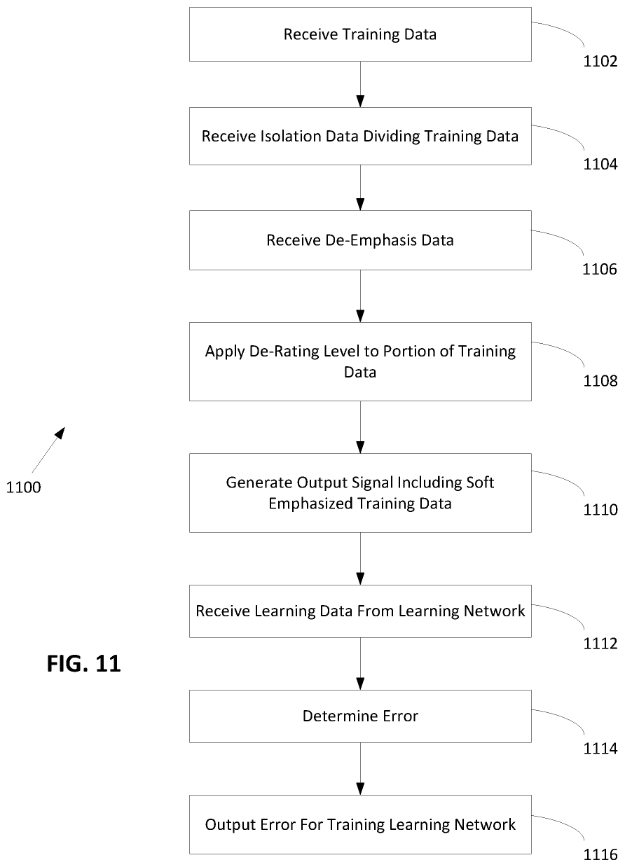

A better understanding of the operation of the training station 200 shown in FIG. 2 may be gathered from a more detailed explanation of the manner in which processor 220 executes the training station logic 250 stored in the memory device 214 for controlling the operation of the training station 200 in accordance with the example embodiments described herein will be provided in the following paragraphs with reference to FIG. 3 which provides an example embodiment of the training station logic 250, FIG. 4 provides an example of a first training image displayed on the visual display unit FIGS. 5 and 9 which provide an example of a selected closed shape applied to the first training image of FIG. 4, FIGS. 6a-6c which provide examples of selected closed shapes available for application to the first training image of FIG. 4, FIGS. 7a and 10a which provide examples of conceptual cross-sections showing de-rating levels being applied to the training data in accordance with the example embodiment, FIGS. 7b and 10b which provide illustrations of resultant smooth continuous applications of the de-rating level at left and right boundaries dividing the first training data into the first and second portions, and FIG. 11 which provides an a flowchart of a method for training an associated learning network using pre-processed training images in accordance with an example embodiment.

FIG. 3 is a block diagram of selected control logic modules of the training station logic 250 stored in the memory device 214 and executed by the training station 200 of FIG. 2 for controlling the operation of the training station 200 in accordance with the example embodiments described herein. The training station logic 250 generally includes an image pre-processing logic portion 252 and a network training logic portion 254.

The image pre-processing logic portion 252 of the training station logic 250 stored in the memory device 214 is executable by the processor 220 of the training station 200 of FIG. 2 and includes in the example embodiment, training data receiving logic 310, isolation data receiving logic 320, de-emphasis receiving logic 330, and soft-emphasized training data logic 340.

The training data receiving logic 310 is provided and is operative in general to receive the training data in the form of training images in the example embodiment into the processor 220 for pre-processing in accordance with the example embodiment. In general, the training data is representative of a training image received at a first input of the training station 200. In an example embodiment, the training data is representative of a training image and comprises training image data representative of a training image pattern in the training image, and extraneous image data representative of one or more extraneous image patterns in the training image.

The isolation data receiving logic 320 is provided and is operative in general to receive isolation data defining boundaries in the training data. In general, the isolation data is representative of a selected closed shape segregating the training data into a first portion within a boundary defined by the closed shape and a second portion outside of the boundary. In an example embodiment, the isolation data is representative of a selected closed shape defining a boundary dividing the training data into first and second portions. The first portion of the training data comprises the training image data representative of the training image pattern and is segregated from the second portion of the training data by the selected closed shape, and the second portion of the training data is segregated from the first portion of the first training data by the selected closed shape.

The de-emphasis receiving logic 330 is provided and is operative in general to receive de-emphasis data for deemphasizing or otherwise de-rating selected portions of the training data divided by the boundaries.

The soft-emphasized training data logic 340 is provided and is operative in general to apply the de-emphasis data to the training images and to deliver the pre-processed training data images to the network training logic portion 254 of the training station logic 250 stored in the memory device 214 and executed by the processor 220 of the training station 200 of FIG. 2. In general, the soft-emphasized training data logic 340 applies a de-rating level to the training data to form soft-emphasized training data by a gradual application of the de-rating level to the second portion of the training data from a foregoing of the application of the de-rating level at the first portion of the training data within the boundary and at the boundary between the first and second portions of the training data, and by an increasing application of the de-rating level to the second portion of the training data from the boundary outwardly from the selected closed shape.

In one example, a gradual or soft change such as a decrease of image or pixel values towards lower values or even black, wherein black may be defined when the pixel values are all zero (0), may be used to deemphasize or otherwise obscure the second portion of the training images from the training of the deep learning network. As a further particular example, a gradual or soft change such as a gradual blending of noise from original pixel values of the training images to noise-added-pixel values may be used to deemphasize or otherwise obscure the second portion of the training images from the training of the deep learning network. As still yet a further particular example, a gradual or soft change such as a gradual blurring of the original pixel values of the training images to blurred versions of the pixel values may be used to deemphasize or otherwise obscure the second portion of the training images from the training of the deep learning network.

As yet a further particular example, a gradual or soft change such as a decrease of image or pixel values towards lower values or even black (black is when the pixel values are all 0) in combination with a gradual blending of noise from original pixel values of the training images to noise-added-pixel values may be used to deemphasize or otherwise obscure the second portion of the training images from the training of the deep learning network.

As yet a still further particular example, a gradual or soft change such as a gradual blending of noise from original pixel values of the training images to noise-added-pixel values in combination with a gradual or soft change such as a gradual blurring of the original pixel values of the training images to blurred versions of the pixel values may be used to deemphasize or otherwise obscure the second portion of the training images from the training of the deep learning network.

As still a yet further particular example, a gradual or soft change such as a decrease of image or pixel values towards lower values or even black (black is when the pixel values are all 0) in combination with a gradual blending of noise from original pixel values of the training images to noise-added-pixel values in combination with a gradual or soft change such as a gradual blurring of the original pixel values of the training images to blurred versions of the pixel values may be used to deemphasize or otherwise obscure the second portion of the training images from the training of the deep learning network.

In a particular example embodiment, the soft-emphasized training data logic 340 applies the de-rating level to the training data to form the soft-emphasized training data by applying the de-rating level to the training data in accordance with a full application of the de-rating level to the second portion of the training data thereby reducing effects of extraneous image data in the soft-emphasized training data, foregoes the application of the de-rating level to the first portion of the training data thereby preserving the training image data representative of the training image pattern in the soft-emphasized training data, and by applying a gradient of the application of the de-rating level beginning at the boundary dividing the first training data into the first and second portions and extending outwardly wherein the outermost portions of the training data are deemphasized more than the portions of the training data near to the boundary. The soft-emphasized training data logic 340 further generates an output signal at a first output of the training station 200. The output signal is representative of the soft-emphasized training data for training an associated deep learning network to recognize a pattern in the training data.

The network training logic portion 254 of the training station logic 250 stored in the memory device 214 and executed by the processor 220 of the training station 200 of FIG. 2 includes in the example embodiment, training data delivery logic 350, decision receiving logic 360, error determination logic 370; and error backpropagate logic 380.

The training data delivery logic 350 is provided and is operative in general to deliver the pre-processed data to an input layer of the associated learning network 210. In an embodiment, the training data delivery logic 350 generates an output signal at a first output of the training station, the output signal being representative of the soft-emphasized training data for training an associated deep learning network to recognize a pattern in the training data.

The decision receiving logic 360 is provided and is operative in general to receive an output decisions, such as an image classification output decision for example, from an output layer of the associated learning network 210.

The error determination logic 370 is provided and is operative in general to compare the output decision received from the output layer of the associated learning network 210 with a target pattern and to determine an error or difference between the two.

The error backpropagate logic 380 is provided and is operative in general to generate a signal for use by the associated learning network to initiate by the network backpropagating the determined error to nodes of the associated learning network 210 for training the network.

With continued reference to FIGS. 1-3 and with additional reference to FIG. 4 in accordance with the example embodiment, first training data is received at a first input of a training station 200 operatively coupled with the associated deep learning network. The first training data may be received from the large data store 216 via the conductor 215, from an associated external source via the interface processor 230, from an associated external source into the training data receiving logic 310 of the training station logic 250 (FIG. 3), by other means, or any combination thereof. The training station is operative to display the received training data, preferably one image at a time, on the visual display unit 212.

The first training data is representative of a first training image 400 and comprises first training image data representative of a first training image pattern 410 in the first training image 400, and first extraneous image data representative of one or more first extraneous image patterns 420, 422, and 424 in the first training image 400. In the example shown in FIG. 4, the first training image 400 comprises a first training image pattern 410 in the first training image 400 in the form of a sailboat image 430. Further in the example shown in FIG. 4, one or more first extraneous image patterns 420, 422, and 424 in the first training image 400 comprise extraneous images in the forms of a bird 440, a cloud 442, and waves 444.

With continued reference to FIGS. 1-4 and with additional reference to FIG. 5 in accordance with the example embodiment, an example of a selected closed shape applied to the first training image of FIG. 4 accordance with an embodiment of the present disclosure is illustrated. First isolation data is received at a second input of the training station 200. The first isolation data may be received from the large data store 216 via the conductor 215, from an associated external source via the interface processor 230, from an associated external source into the isolation data receiving logic 320 of the training station logic 250 (FIG. 3), by other means, or any combination thereof. The training station 200 is operative to display the received isolation data, preferably on the visual display unit 212.

In the example embodiment, the first isolation data is representative of a selected closed shape 500 defining a boundary 502 dividing the first training data representative of a first training image pattern 410 into first 510 and second 520 portions. The first portion 510 of the first training data comprising the first training image data representative of the first training image pattern 410 is segregated from the second portion 520 of the first training data by the selected closed shape 500. Similarly and correspondingly, the second portion 520 of the first training data is segregated from the first portion 510 of the first training data by the selected closed shape 500. The selected closed shape 500 illustrated in FIG. 5 is a closed geometric shape 530 in the form of a square 532.

The selected closed shapes can take on any form and may be necessary and/or desired. In this regard, the selected closed shape 500 shown in FIG. 6a is a closed geometric shape 530 in the form of a circle 600 dividing the first training image into first 510 and second 520 portions. A user of the training station 200 (FIG. 2) may select the shape from a menu option presented on the screen 212 or alternatively draw the circle 600 dividing the first training image displayed on the visual display unit 212 by using one or more of the pen drawing tool 218, the keyboard 240, and/or the computer mouse device 242. Similarly, the selected closed shape 500 shown in FIG. 6b is a further closed geometric shape 530 in the form of a rectangle 602 dividing the first training image into first 510 and second 520 portions. A user of the training station 200 (FIG. 2) may select the shape from a menu option presented on the screen 212 or alternatively draw the rectangle 602 dividing the first training image displayed on the visual display unit 212 by using one or more of the pen drawing tool 218, the keyboard 240, and/or the computer mouse device 242. Still yet further, the selected closed shape 500 shown in FIG. 6c is a closed user-selected free form shape 604 in the form of a lasso 606 dividing the first training image into first 510 and second 520 portions. A user of the training station 200 (FIG. 2) may draw the lasso 606 dividing the first training image displayed on the visual display unit 212 by using one or more of the pen drawing tool 218, the keyboard 240, and/or the computer mouse device 242.

With continued reference to FIGS. 1-5 and further in accordance with the example embodiment, first de-emphasis data is received at a third input of a training station 200 operatively coupled with the associated deep learning network. The first de-emphasis data may be received from the large data store 216 via the conductor 215, from an associated external source via the interface processor 230, from an associated external source into the de-emphasis data receiving logic 330 of the training station logic 250 (FIG. 3), by other to means, or any combination thereof. The training station is operative to display the received training data, preferably one image at a time, on the visual display unit 212 together with the de-emphasis data applied thereto. The first de-emphasis data is representative of a first de-rating level to be applied to one or more selected portions of the first training data. In one example, a de-rating value is applied to portions of the training data outside of the boundaries so that this portion of the training data may be deemphasized or otherwise obscured for the training. As a particular example, a gradual or soft change such as a decrease of image or pixel values towards lower values or even black (black is when the pixel values are all 0) may be used to deemphasize or otherwise obscure the second portion of the training images from the training of the deep learning network. As a further particular example, a gradual or soft change such as a gradual blending of noise from original pixel values of the training images to noise-added-pixel values may be used to deemphasize or otherwise obscure the second portion of the training images from the training of the deep learning network. As still yet a further particular example, a gradual or soft change such as a gradual blurring of the original pixel values of the training images to blurred versions of the pixel values may be used to deemphasize or otherwise obscure the second portion of the training images from the training of the deep learning network. Preferably and in accordance with the example embodiment, the first de-rating level is applied to the second portion 520 (FIG. 5) of the first training data which is segregated from the first portion 510 of the first training data by the selected closed shape 500.

In accordance with an embodiment, the first de-emphasis data is representative of a first de-rating level in the range of greater than zero percent (0%) to one hundred percent (100%). A de-rating level in the range of near to zero percent (0%) only slightly obliterates the image data information contained in the outer regions of the second portion 520 (FIG. 5) of the first training data which is segregated from the first portion 510 of the first training data by the selected closed shape 500. A de-rating level in the range of near to one hundred percent (100%) nearly completely obliterates the image data information contained in the outer regions of the second portion 520 (FIG. 5) of the first training data which is segregated from the first portion 510 of the first training data by the selected closed shape 500.

The first de-rating level is applied by the soft-emphasized training data logic 340 of the training station logic 250 (FIG. 3) to the first training data to form soft-emphasized training data. Preferably, the first de-rating level is applied to the first training data in accordance with a full application of the de-rating level to the second portion of the first training data thereby reducing effects of the first extraneous image data in the soft-emphasized training data. Also preferably, the first de-rating level is applied to the first training data by foregoing of the application of the de-rating level to the first portion of the first training data thereby preserving the first training image data representative of the first training image pattern in the soft-emphasized training data. Still yet also preferably, the first de-rating level is applied to the first training data by a gradual (soft) continuous decrease and/or change of image pixel values towards lower values, as a decreasing slope. A gradient of this soft slope is preferably smooth at the boundary 502 (FIG. 5) dividing the first training data into the first and second portions.

FIG. 7a is an illustration of a conceptual cross-section of the first de-rating level being applied to the training data in accordance with the example embodiment and taken through line 7a-7a of FIG. 5, and FIG. 7b is an illustration of a resultant continuous gradients of the application of the de-rating level at the left 503 and right 504 boundaries (FIG. 5) dividing the training data into the first and second portions. The x-axis represents horizontal positions in the training image 400 of FIGS. 4 and 5, and the y-axis represents an intensity of the de-emphasis level to be applied to the training image 400 wherein 710 represents full application of the de-rating level and 712 represents no (forgoing) application of the de-rating level in accordance with an embodiment. As shown first in the de-rating graph 700 of FIG. 7a, the first de-rating level is applied to the training data in accordance with a full application 710 of the de-rating level to the outer regions of the second portion 520 (FIG. 5) of the training data and in accordance with a user-defined slope M (and −M) thereby reducing effects of the first extraneous image data in the soft-emphasized training data. Also preferably, the first de-rating level is not applied to the training data by foregoing of the application 712 of the de-rating level to the first portion 510 (FIG. 5) of the first training data thereby preserving the training image data representative of the first training image pattern in the soft-emphasized training data. Still yet also preferably and as shown in the gradient graph 702 of FIG. 7b, the first de-rating level is applied to the training data by continuous gradients 720, 722 of the application of the de-rating level at the left 503 and right 504 boundaries (FIG. 5), the boundaries 503, 504 dividing the first training data into the first and second portions.

FIG. 7c is an illustration of a conceptual cross-section of the first de-rating level being non-linearly applied to the first training data in accordance with the example embodiment and taken through line 7c-7c of FIG. 5, and FIG. 7d is an illustration of resultant smooth continuous gradients of the non-linear application of the de-rating level at the left 503 and right 504 boundaries (FIG. 5) dividing the first training data into the first and second portions. The x-axis represents horizontal positions in the training image 400 of FIGS. 4 and 5, and the y-axis represents an intensity of the de-emphasis level to be applied to the training image 400 wherein 710′ represents full application of the de-rating level and 712′ represents no (forgoing) application of the de-rating level in accordance with an embodiment. As shown first in the de-rating graph 700′ of FIG. 7c, the first de-rating level is applied non-linearly to the first training data in accordance with an application 710′ of a logistic function of the full de-rating level to the second portion 520 (FIG. 5) of the first training data thereby reducing effects of the first extraneous image data in the soft-emphasized training data. Also preferably, the first de-rating level is applied to the first training data by foregoing of the application 712′ of the de-rating level to the first portion 510 (FIG. 5) of the first training data thereby preserving the first training image data representative of the first training image pattern in the soft-emphasized training data. Still yet also preferably and as shown in the gradient graph 702′ of FIG. 7b, the first de-rating level is applied non-linearly to the first training data by smooth continuous gradients 720′, 722′ of the application of the de-rating level at the left 503 and right 504 boundaries (FIG. 5), the boundaries 503, 504 dividing the first training data into the first and second portions.

In the example embodiment, the logistic function is a function having a common “S” shape (sigmoid curve, for example) of the form:

$$F ( x ) = \frac{L}{1 + {e}^{- k ( x - x 0 )}}$$

where e is the natural logarithm base (also known as Euler's number), x0 is the x-value of the sigmoid's midpoint, L is the curve's maximum value, and k is the “steepness” of the curve. It is to be appreciated that any other or more generalized logistic functions or curves (such as Richards' curve) having a smooth transition of the application of the de-rating levels or values at the boundary between image portions may be used equivalently.

The example embodiments provide significant advantages and improvements in training learning networks when only a small set of training images are available. Portions 510 of the training images 400 that contain the training image pattern 410 are segregated or otherwise isolated from other portions 520 of the training images 400 not having the training image patterns, but instead having extraneous image patterns 420, 422, 424. These portions of the training images not having the training image patterns may be de-emphasized or at least partially obliterated such as by whiting-out or blackening-out those portions by applying the de-rating level to the images by the soft-emphasized training data logic 340. Importantly, however, the technique of this solution avoids the side effects of possibly training the boundary 502 into the learning network by implementing the smooth continuous de-emphasis gradient exercised at the boundary between the fully presented portions 510 of the training images and the deemphasized or obscured portions 520 of the training images. In this way, the smooth continuous de-emphasis gradient exercised at the boundary helps to prevent the boundary from being used itself as training data.

By way of contrast and for purposes of illustrating some significant advantages of the example embodiment over earlier methods, FIG. 8b is an illustration of a conceptual cross-section of the first de-rating level being applied to the first training data in accordance with an earlier all-or-nothing protocol and taken through line 8a-8a of FIG. 5, and FIG. 8b is an illustration of resultant discontinuous pulse type gradients of the application of the de-rating level at the left 503 and right 504 boundaries (FIG. 5) dividing the first training data into the first and second portions. As shown first in the de-rating graph 800 of FIG. 8a, the first de-rating level is applied to the first training data in accordance with an immediate full application 810 of a de-rating level to the second portion 520 (FIG. 5) of the first training data at the transitions 503, 504 between the first and second portions of the training data. This reduces effects of the first extraneous image data in the soft-emphasized training data but has severe side effects because the demarcation in the training images that are used to separate the relevant from the non-relevant portions of the training image is itself interpreted by the network being trained as useful information. This confounds the deep learning training protocol as the learning network essentially trains on the edge of the boundary. Also, a first de-rating level is applied to the first training data by foregoing of the application 812 of the de-rating level to the first portion 510 (FIG. 5) of the first training data thereby preserving the first training image data representative of the first training image pattern in the soft-emphasized training data. Still yet also as shown in the gradient graph 802 of FIG. 8b, the first de-rating level is applied to the first training data by using the earlier discontinuous approach produces discontinuous pulse type gradients 820, 822 of the application of the de-rating level at the left 503 and right 504 boundaries (FIG. 5) dividing the first training data into the first and second portions. Again, the discontinuous pulse type gradients produced generate a pronounced demarcation line in the training images which is itself interpreted by the network being trained as useful information. This confounds the deep learning training protocol as the learning network essentially trains on the edge of the boundary.

A comparison between the gradient graphs 702, 702′ of FIGS. 7b, 7d showing the de-rating levels applied to the training data by continuous gradients 720, 722 (FIGS. 7a, 7b) and smooth continuous gradients 720′, 722′ (FIGS. 7c, 7d) of the application of the de-rating level at the left 503 and right 504 boundaries (FIG. 5) dividing the first training data into the first and second portions against the gradient graph 802 of FIG. 8b showing the first de-rating level applied to the first training data by using the earlier discontinuous approach producing the discontinuous pulse type gradients 820, 822 of the application of the de-rating level at the left 503 and right 504 boundaries (FIG. 5) dividing the first training data into the first and second portions clearly demonstrates the advantages of the embodiments of the invention relating to training learning networks when only a small set of training images are available. The boundaries are not inadvertently or collaterally learned by the networks during their training in accordance with the embodiments of the claimed invention herein.

In accordance with a further example embodiment, a transition band having a selectable width is used to divide the first training data into the first and second portions. In this regard, the first isolation data received at the second input of the training station comprises receiving first isolation data representative of a selected closed shape defining a transition band having a selectable width. The transition band having the selectable width dividing the first training data into the first and second portions.

With continued reference to FIGS. 1-5, 6a-6c, 7a, and 7b, and with additional reference to FIG. 9 in accordance with a further example embodiment, an example of a selected closed shape having a selectable width is applied to the first training image of FIG. 4 accordance with an embodiment of the present disclosure is illustrated. First isolation data is received at a second input of the training station 200. The first isolation data may be received from the large data store 216 via the conductor 215, from an associated external source via the interface processor 230, from an associated external source into the isolation data receiving logic 320 of the training station logic 250 (FIG. 3), by other means, or any combination thereof. The training station 200 is operative to display the received isolation data, preferably on the visual display unit 212.

In the example embodiment, the first isolation data is representative of a selected closed shape 900 defining a boundary 902 having a selectable width 950 and dividing the first training data representative of a first training image pattern 410 into first 910 and second 920 portions. The first portion 910 of the first training data comprising the first training image data representative of the first training image pattern 410 is segregated from the second portion 920 of the first training data by the selected closed shape 900 having the user-selectable width 950. Similarly and correspondingly, the second portion 920 of the first training data is segregated from the first portion 910 of the first training data by the selected closed shape 900 having the user-selectable width 950.

The selected closed shape 900 illustrated in FIG. 9 is a closed geometric shape 930 in the form of a square 932. However, it is to be appreciated that the selected closed shape can take on any form and may be necessary and/or desired. In this regard, the selected closed shape 900 may be a closed geometric shape in the form of a circle (not shown) dividing the first training image into first 910 and second 920 portions. A user of the training station 200 (FIG. 2) may select the shape from a menu option presented on the screen 212 or alternatively draw the circle 900 dividing the first training image displayed on the visual display unit 212 by using one or more of the pen drawing tool 218, the keyboard 240, and/or the computer mouse device 242. Similarly, the selected closed shape 900 may be a closed geometric shape 930 in the form of a rectangle (not shown) dividing the first training image into first 910 and second 920 portions. Still yet further, the selected closed shape 900 shown in FIG. 9c may be a closed user-selected free form shape in the form of a lasso (not shown) dividing the first training image into first 910 and second 920 portions. A user of the training station 200 (FIG. 2) may draw the lasso dividing the first training image displayed on the visual display unit 212 by using one or more of the pen drawing tool 218, the keyboard 240, and/or the computer mouse device 242.

With continued reference to FIG. 9, the first de-emphasis data is received at a third input of a training station 200 operatively coupled with the associated deep learning network. The first de-emphasis data may be received from the large data store 216 via the conductor 215, from an associated external source via the interface processor 230, from an associated external source into the de-emphasis data receiving logic 330 of the training station logic 250 (FIG. 3), by other means, or any combination thereof. The training station is operative to display the received training data, preferably one image at a time, on the visual display unit 212 together with the de-emphasis data applied thereto. The first de-emphasis data is representative of a first de-rating level to be applied to one or more selected portions of the first training data. Preferably and in accordance with the example embodiment, the first de-rating level is applied to the second portion 920 of the first training data which is segregated from the first portion 910 of the first training data by the selected closed shape 900.

In accordance with an embodiment, the first de-emphasis data is representative of a first de-rating level in the range of greater than zero percent (0%) to one hundred percent (100%). A de-rating level in the range of near to zero percent (0%) only slightly obliterates the image data information contained in the second portion 920 of the first training data which is segregated from the first portion 910 of the first training data by the selected closed shape 900. A de-rating level in the range of near to one hundred percent (100%) nearly completely obliterates the image data information contained in the second portion 920 of the first training data which is segregated from the first portion 910 of the first training data by the selected closed shape 900.

The first de-rating level is applied by the soft-emphasized training data logic 340 of the training station logic 250 (FIG. 3) to the first training data to form soft-emphasized training data. Preferably, the first de-rating level is non-linearly applied to the first training data in accordance with a full application of the de-rating level to the second portion of the first training data by using the logistic function within the region 950 bounded between the inner selected region 903/904 and the outer selected region 903′/904′ thereby reducing effects of the first extraneous image data in the soft-emphasized training data. Also preferably, the first de-rating level is applied to the first training data by foregoing of the application of the de-rating level to the first portion of the first training data thereby preserving the first training image data representative of the first training image pattern in the soft-emphasized training data. Still yet also preferably, the first de-rating level is applied to the first training data by a smooth continuous gradient of the application of the de-rating level at the boundary 902 dividing the first training data into the first and second portions and having the user-defined width 950.

FIG. 10a is an illustration of a conceptual cross-section of the first de-rating level being applied to the first training data using a non-linear logistic function in accordance with the example embodiment and taken through line 10a-10a of FIG. 9, FIG. 10b is an illustration of resultant smooth continuous gradients of the application of the de-rating level at the left boundaries 903, 903′ and the right boundaries 904, 904′ (FIG. 9) dividing the first training data into the first and second portions; and FIG. 10a is an illustration of a conceptual cross-section of the first de-rating level being applied to the first training data using a non-linear logistic function in accordance with the example embodiment and taken through line 10a-10a of FIG. 9.

As shown first in the de-rating graph 1000 of FIG. 10a, the first de-rating level is applied to the first training data in accordance with a full application 1010 of the de-rating level to the second portion 920 (FIG. 9) of the first training data thereby reducing effects of the first extraneous image data in the soft-emphasized training data. Also preferably, the first de-rating level is applied to the first training data by foregoing of the application 1012 of the de-rating level to the first portion 910 (FIG. 9) of the first training data thereby preserving the first training image data representative of the first training image pattern in the soft-emphasized training data. Still yet also preferably and as shown in the gradient graph 1002 of FIG. 10b, the first de-rating level is applied to the first training data by smooth continuous gradients 1020, 1022 of the application of the de-rating level at the left boundaries 903, 903′ and the right boundaries 904, 904′ (FIG. 9) dividing the first training data into the first and second portions.

As further shown first in the de-rating graph 1004 of FIG. 10c, the first de-rating level is applied to the first training data in accordance with a full application 1010 of the de-rating level to the second portion 920 (FIG. 9) of the first training data thereby reducing effects of the first extraneous image data in the soft-emphasized training data. Also preferably, the first de-rating level is applied to the first training data by foregoing of the application 1012 of the de-rating level to the first portion 910 (FIG. 9) of the first training data thereby preserving the first training image data representative of the first training image pattern in the soft-emphasized training data. Still yet also preferably in the example embodiment illustrated in the graph 1004 of FIG. 10c, the first de-rating level is applied to the first training data by first linear gradients 1030, 1032 of the application of the de-rating level at the left boundary band 903-903′ and the right boundary band 904-904′ (FIG. 9) dividing the first training data into the first and second portions. Full application of the de-rating level is applied to the first training data by second linear gradients 1040, 1042 of the application of the de-rating level at the left boundary band 903-903′ and the right boundary band 904-904′ (FIG. 9) dividing the first training data into the first and second portions.

The example embodiments provide significant advantages and improvements in training learning networks when only a small set of training images are available. The user selectable width 950 of the boundary 902 allows for a smooth continuous de-emphasis gradient having, essentially, a user-selectable width, to be exercised at the boundary helps to prevent the boundary from being used itself as training data. Importantly, the technique of this solution avoids the side effects of possibly training the wide and gradual boundary 902 into the learning network by implementing the smooth continuous de-emphasis gradient exercised at the boundary between the fully presented portions 910 of the training images and the deemphasized or obscured portions 920 of the training images.

FIG. 11 illustrates a flowchart of a method 1100 for training an associated deep learning network to recognize a target pattern using pre-processed training images in accordance with an example embodiment. In the example embodiment, the images used to train the learning network are pre-processed in steps 1102-1108 by the image pre-processing logic portion 252 that, when executed by one or more processors of a training system, cause the training system to perform image pre-processing steps comprising executing the training data receiving logic 310, the isolation data receiving logic 320, the de-emphasis receiving logic 330, and the soft-emphasized training data logic 340. The steps include, in the example embodiment, receiving training data representative of a training image at a first input of a training station, receiving isolation data at a second input of the training station, the isolation data being representative of a selected closed shape segregating the training data into a first portion within a boundary defined by the closed shape and a second portion outside of the boundary; receiving de-emphasis data at a third input of the training station, the de-emphasis data being representative of a de-rating level to be applied to the second portion of the training data; applying the de-rating level to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape.

With reference now to FIG. 11, the method 1100 receives at step 1102 training data at a first input of a training station operatively coupled with the associated deep learning network. The training data is representative of a first training image and comprises first training image data representative of a first training image pattern in the first training image, and first extraneous image data representative of one or more first extraneous image patterns in the first training image.

Isolation data is received in step 1104. The isolation data divides the training data into first and second portions by a boundary. In general and according to an example embodiment, the first isolation data is representative of a selected closed shape defining a boundary dividing the training data into first and second portions. The first portion of the first training data comprises the first training image data representative of the first training image pattern and is segregated from the second portion of the first training data by the selected closed shape. The second portion of the first training data is segregated from the first portion of the first training data by the selected closed shape.

De-emphasis data is received at step 1106 at a third input of the training station. The de-emphasis data is representative of a first de-rating level to be applied to one or more selected portions of the first training data.

The first de-rating level is applied in step 1108 to the first training data to form soft-emphasized training data by applying the first de-rating level to the first training data in accordance with: a full application of the de-rating level to the second portion of the first training data thereby reducing effects of the first extraneous image data in the soft-emphasized training data, and a foregoing of the application of the de-rating level to the first portion of the first training data thereby preserving the first training image data representative of the first training image pattern in the soft-emphasized training data. The full application of the de-rating level to the second portion of the first training data includes in accordance with an example embodiment applying the de-rating level to the training data by linearly increasing the application of the de-rating level to the second portion of the training data from the boundary outwardly from the selected closed shape. The full application of the de-rating level to the second portion of the first training data includes in accordance with a further example embodiment gradually applying the de-rating level to the training data by non-linearly increasing the application of the de-rating level to the second portion of the training data from the boundary outwardly from the selected closed shape in accordance with a logistic function.

The learning network is trained in steps 1110-1118. In the example embodiment, the learning network is trained in steps 1110-1118 by the network training logic portion 254 that, when executed by one or more processors of a training system, cause the training system to perform steps comprising executing the training data delivery logic 350, the decision receiving logic 360, the error determination logic 370; and the error backpropagate logic 380. The steps include, in the example embodiment, generating an output signal at a first output of the training station, the output signal being representative of the soft-emphasized training data for training an associated deep learning network to recognize a pattern in the training data; receiving learning data at a fourth input of the training station from the associated deep learning network, the learning data being representative of a learned pattern learned by the associated deep learning network responsive to the output signal generated at the first output of the training station; determining by the training station an error based on a comparison between target pattern data representative of a training target pattern contained in the training data and the learning data representative of the learned pattern learned by the associated deep learning network; and generating an error output signal at a second output of the training station, the error output signal being representative of the determined error for back-propagating the error by the associated deep learning network for the training.

At step 1112 the pre-processed soft-emphasized training data images are outputted to the learning network. Preferably, the soft-emphasized training data is delivered by the training station to an input of the associated deep learning network. The training station receives from an output of the associated deep learning network, first learning data representative of a first learned pattern learned by the associated deep learning network responsive to the associated deep learning network receiving the soft-emphasized training data.

The training station receives learning data form the learning network in step 1112 and determines an error at step 1114 based on a comparison between target pattern data representative of the target pattern and the first learning data representative of the first learned pattern learned by the associated deep learning network. The error is outputted in step 1118 to be backpropagated by the training station to nodes of the associated deep learning network to effect the training.

Embodiments described herein provide various benefits. In particular, embodiments enable the training of learning machines where a corresponding set of training images is small. The embodiments described herein provide a solution that enables users to select relevant portions of the images contained in the training image set without the adverse consequences of the mere data selection itself from becoming a part of the learned body of information.

Although the descriptions have been described with respect to particular embodiments thereof, these particular embodiments are merely illustrative, and not restrictive.

Any suitable programming language can be used to implement the routines of particular embodiments including Python, OpenCL, CUDA, C, C++, Java, assembly language, etc. Different programming techniques can be employed such as procedural or object oriented. The routines can execute on a single processing device or multiple processors preferably with multiple cores. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

In an example embodiment, a non-transitory computer readable medium is provided including instructions thereon which, when executed by one or more processors of a training system, cause the training system to perform steps comprising: receiving training data representative of a training image at a first input of a training station, receiving isolation data at a second input of the training station, the isolation data being representative of a selected closed shape segregating the training data into a first portion within a boundary defined by the closed shape and a second portion outside of the boundary; receiving de-emphasis data at a third input of the training station, the de-emphasis data being representative of a de-rating level to be applied to the second portion of the training data; applying the de-rating level to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape; generating an output signal at a first output of the training station, the output signal being representative of the soft-emphasized training data for training an associated deep learning network to recognize a pattern in the training data; receiving learning data at a fourth input of the training station from the associated deep learning network, the learning data being representative of a learned pattern learned by the associated deep learning network responsive to the output signal generated at the first output of the training station; determining by the training station an error based on a comparison between target pattern data representative of a training target pattern contained in the training data and the learning data representative of the learned pattern learned by the associated deep learning network; and generating an error output signal at a second output of the training station, the error output signal being representative of the determined error for back-propagating the error by the associated deep learning network for the training.

In the example embodiment the non-transitory computer readable medium provided including the instructions thereon which, when executed by the one or more processors of the training system, causes the training system to perform the further steps comprising: applying the de-rating level to the training data by linearly increasing the application of the de-rating level to the second portion of the training data from the boundary outwardly from the selected closed shape.

In the example embodiment the non-transitory computer readable medium provided including the instructions thereon which, when executed by the one or more processors of the training system, causes the training system to perform the further steps comprising gradually applying the de-rating level to the training data by non-linearly increasing the application of the de-rating level to the second portion of the training data from the boundary outwardly from the selected closed shape in accordance with a logistic function.

In the example embodiment the non-transitory computer readable medium provided including the instructions thereon which, when executed by the one or more processors of the training system, causes the training system to perform the further steps comprising receiving de-emphasis data representative of a de-rating slope to be applied to the second portion of the training data, and applying the de-rating level to the training data by linearly increasing the application of the de-rating level to the second portion of the training data from the boundary outwardly from the selected closed shape in accordance with the de-rating slope.

In the example embodiment the non-transitory computer readable medium provided including the instructions thereon which, when executed by the one or more processors of the training system, causes the training system to perform the further steps comprising receiving de-emphasis data representative of parameters of the logistic function to be applied to the second portion of the training data and applying the de-rating level to the training data by non-linearly increasing the application of the de-rating level to the second portion of the training data from the boundary outwardly from the selected closed shape in accordance with the logistic function using the parameters.

In the example embodiment the non-transitory computer readable medium provided including the instructions thereon which, when executed by the one or more processors of the training system, causes the training system to perform the further steps comprising receiving darkening de-emphasis data, the darkening de-emphasis data being representative of a darkening de-rating level to be applied to the second portion of the training data, and applying the darkening de-rating level to form the soft-emphasized training data by an increasing application of the darkening de-rating level to pixels of the training image in the second portion of the training data from the boundary outwardly from the selected closed shape thereby gradually blending the pixels of the training image in the second portion of the training from a non-darkened condition at the boundary between the first and second portions to a darkened condition outwardly from the selected closed shape in accordance with the darkening de-rating level.

In the example embodiment the non-transitory computer readable medium provided including the instructions thereon which, when executed by the one or more processors of the training system, causes the training system to perform the further steps comprising receiving blurring de-emphasis data, the blurring de-emphasis data being representative of a blurring de-rating level to be applied to the second portion of the training data, and applying the blurring de-rating level to form the soft-emphasized training data by an increasing application of the blurring de-rating level to pixels of the training image in the second portion of the training data from the boundary outwardly from the selected closed shape thereby gradually blending the pixels of the training image in the second portion of the training from a non-blurred condition at the boundary between the first and second portions to a blurred condition outwardly from the selected closed shape in accordance with the blurring de-rating level.

In the example embodiment the non-transitory computer readable medium provided including the instructions thereon which, when executed by the one or more processors of the training system, causes the training system to perform the further steps comprising receiving noise de-emphasis data, the noise de-emphasis data being representative of a noise de-rating level to be applied to the second portion of the training data, and applying the noise de-rating level to form the soft-emphasized training data by an increasing application of the noise de-rating level to pixels of the training image in the second portion of the training data from the boundary outwardly from the selected closed shape thereby gradually blending the pixels of the training image in the second portion of the training from an added noise free condition at the boundary between the first and second portions to a noise added condition outwardly from the selected closed shape in accordance with the noise de-rating level.

In the example embodiment the non-transitory computer readable medium provided including the instructions thereon which, when executed by the one or more processors of the training system, causes the training system to perform the further steps comprising receiving one or more of darkening de-emphasis data, blurring de-emphasis data, and/or noise de-emphasis data, the darkening de-emphasis data being representative of a darkening de-rating level to be applied to the second portion of the training data, the blurring de-emphasis data being representative of a blurring de-rating level to be applied to the second portion of the training data, and the noise de-emphasis data being representative of a noise de-rating level to be applied to the second portion of the training data, and applying the one or more of the darkening de-rating level, the blurring de-rating level, and/or the noise de-rating level to form the soft-emphasized training data by an increasing application of the darkening, blurring and/or noise de-rating level to pixels of the training image in the second portion of the training data from the boundary outwardly from the selected closed shape thereby gradually blending the pixels of the training image in the second portion of the training from a darkening, blurring and/or noise free condition at the boundary between the first and second portions to a darkening, blurring and/or noise added condition outwardly from the selected closed shape in accordance with the noise de-rating level.

In the example embodiment the non-transitory computer readable medium provided including the instructions thereon which, when executed by the one or more processors of the training system, causes the training system to perform the further steps comprising receiving isolation data representative of a selected closed geometric shape segregating the training data into a first portion within a boundary defined by the closed geometric shape and a second portion outside of the boundary.

In the example embodiment the non-transitory computer readable medium provided including the instructions thereon which, when executed by the one or more processors of the training system, causes the training system to perform the further steps to comprising isolation data representative of a selected closed user-defined free-form lasso shape segregating the training data into a first portion within a boundary defined by the closed user-defined free-form lasso shape and a second portion outside of the boundary.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method of training a deep learning network, comprising:
receiving training data representative of a training image at a first input of a training station;
receiving isolation data at a second input of the training station, the isolation data being representative of a selected closed shape segregating the training data into a first portion within a boundary defined by the closed shape and a second portion outside of the boundary;
receiving de-emphasis data at a third input of the training station, the de-emphasis data being representative of a de-rating level to be applied to the second portion of the training data;
applying the de-rating level to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape;
generating an output signal at a first output of the training station, the output signal being representative of the soft-emphasized training data for training an associated deep learning network to recognize a pattern in the training data;
receiving learning data at a fourth input of the training station from the associated deep learning network, the learning data being representative of a learned pattern learned by the associated deep learning network responsive to the output signal generated at the first output of the training station;
determining by the training station an error based on a comparison between target pattern data representative of a training target pattern contained in the training data and the learning data representative of the learned pattern learned by the associated deep learning network; and
generating an error output signal at a second output of the training station, the error output signal being representative of the determined error for back-propagating the error by the associated deep learning network for the training.

2. The method according to claim 1, wherein the applying the de-rating level to the training data by the increasing the application of the de-rating level comprises:
applying the de-rating level to the training data by linearly increasing the application of the de-rating level to the second portion of the training data from the boundary outwardly from the selected closed shape.

3. The method according to claim 1, wherein the applying the de-rating level to the training data by the increasing the application of the de-rating level comprises:
gradually applying the de-rating level to the training data by non-linearly increasing the application of the de-rating level to the second portion of the training data from the boundary outwardly from the selected closed shape in accordance with a logistic function.

4. The method according to claim 1, wherein:
the receiving the de-emphasis data at the third input of the training station comprises receiving de-emphasis data representative of a de-rating slope to be applied to the second portion of the training data; and
the applying the de-rating level to the training data comprises applying the de-rating level to the training data by linearly increasing the application of the de-rating level to the second portion of the training data from the boundary outwardly from the selected closed shape in accordance with the de-rating slope.

5. The method according to claim 1, wherein:
the receiving the de-emphasis data at the third input of the training station comprises receiving de-emphasis data representative of parameters of the logistic function to be applied to the second portion of the training data; and
the applying the de-rating level to the training data comprises applying the de-rating level to the training data by non-linearly increasing the application of the de-rating level to the second portion of the training data from the boundary outwardly from the selected closed shape in accordance with the logistic function using the parameters.

6. The method according to claim 1, wherein:
the receiving the de-emphasis data comprises receiving darkening de-emphasis data, the darkening de-emphasis data being representative of a darkening de-rating level to be applied to the second portion of the training data; and
the applying the de-rating level to the training data comprises applying the darkening de-rating level to form the soft-emphasized training data by an increasing application of the darkening de-rating level to pixels of the training image in the second portion of the training data from the boundary outwardly from the selected closed shape thereby gradually blending the pixels of the training image in the second portion of the training from a non-darkened condition at the boundary between the first and second portions to a darkened condition outwardly from the selected closed shape in accordance with the darkening de-rating level.

7. The method according to claim 1, wherein:
the receiving the de-emphasis data comprises receiving blurring de-emphasis data, the blurring de-emphasis data being representative of a blurring de-rating level to be applied to the second portion of the training data; and
the applying the de-rating level to the training data comprises applying the blurring de-rating level to form the soft-emphasized training data by an increasing application of the blurring de-rating level to pixels of the training image in the second portion of the training data from the boundary outwardly from the selected closed shape thereby gradually blending the pixels of the training image in the second portion of the training from a non-blurred condition at the boundary between the first and second portions to a blurred condition outwardly from the selected closed shape in accordance with the blurring de-rating level.

8. The method according to claim 1, wherein:
the receiving the de-emphasis data comprises receiving noise de-emphasis data, the noise de-emphasis data being representative of a noise de-rating level to be applied to the second portion of the training data; and
the applying the de-rating level to the training data comprises applying the noise de-rating level to form the soft-emphasized training data by an increasing application of the noise de-rating level to pixels of the training image in the second portion of the training data from the boundary outwardly from the selected closed shape thereby gradually blending the pixels of the training image in the second portion of the training from an added noise free condition at the boundary between the first and second portions to a noise added condition outwardly from the selected closed shape in accordance with the noise de-rating level.

9. The method according to claim 1, wherein:
the receiving the de-emphasis data comprises receiving one or more of darkening de-emphasis data, blurring de-emphasis data, and/or noise de-emphasis data, the darkening de-emphasis data being representative of a darkening de-rating level to be applied to the second portion of the training data, the blurring de-emphasis data being representative of a blurring de-rating level to be applied to the second portion of the training data, and the noise de-emphasis data being representative of a noise de-rating level to be applied to the second portion of the training data; and
the applying the de-rating level to the training data comprises applying the one or more of the darkening de-rating level, the blurring de-rating level, and/or the noise de-rating level to form the soft-emphasized training data by an increasing application of the darkening, blurring and/or noise de-rating level to pixels of the training image in the second portion of the training data from the boundary outwardly from the selected closed shape thereby gradually blending the pixels of the training image in the second portion of the training from a darkening, blurring and/or noise free condition at the boundary between the first and second portions to a darkening, blurring and/or noise added condition outwardly from the selected closed shape in accordance with the noise de-rating level.

10. The method according to claim 1, wherein:
the receiving the isolation data at the second input of the training station comprises receiving isolation data representative of a selected closed geometric shape segregating the training data into a first portion within a boundary defined by the closed geometric shape and a second portion outside of the boundary.

11. The method according to claim 1, wherein:
the receiving the isolation data at the second input of the training station comprises receiving isolation data representative of a selected closed user-defined free-form lasso shape segregating the training data into a first portion within a boundary defined by the closed user-defined free-form lasso shape and a second portion outside of the boundary.

12. A deep learning network training station operative to train an associated deep learning network, the training station comprising:
a processor;
a memory device;
training station logic stored in the memory device, the training station logic being executable by the processor to preprocess training image data and to train the associated deep learning network using the preprocessed training images;
a first input operatively coupled with the processor, the first input receiving training data representative of a training image at a first input of a training station;
a second input operatively coupled with the processor, the second input receiving isolation data representative of a selected closed shape segregating the training data into a first portion within a boundary defined by the closed shape and a second portion outside of the boundary; and
a third input operatively coupled with the processor, the third input receiving de-emphasis data representative of a de-rating level to be applied to the second portion of the training data,
wherein the processor is operable to execute the training station logic to apply the de-rating level to the training data to form soft-emphasized training data by a gradual application of the de-rating level to the second portion of the training data from a foregoing of the application of the de-rating level at the boundary between the first and second portions of the training data, and by an increasing application of the de-rating level to the second portion of the training data from the boundary outwardly from the selected closed shape,
wherein the processor is operable to execute the training station logic to generate an output signal at a first output of the training station, the output signal being representative of the soft-emphasized training data for training an associated deep learning network to recognize a pattern in the training data,
wherein the processor is operable to execute the training station logic to receive learning data at a fourth input of the training station from the associated deep learning network, the learning data being representative of a learned pattern learned by the associated deep learning network responsive to the output signal generated at the first output of the training station,
wherein the processor is operable to execute the training station logic to determine an error based on a comparison between target pattern data representative of a training target pattern contained in the training data and the learning data representative of the learned pattern learned by the associated deep learning network,
wherein the processor is operable to execute the training station logic to generate an error output signal at a second output of the training station, the error output signal being representative of the determined error for back-propagating the error by the associated deep learning network for the training.

13. The deep learning network training station according to claim 12, wherein:
the processor is operable to execute the training station logic to apply the de-rating level to the training data by the increasing the application of the de-rating level by linearly increasing the application of the de-rating level to the second portion of the training data from the boundary outwardly from the selected closed shape.

14. The deep learning network training station according to claim 12, wherein:
the processor is operable to execute the training station logic to apply the de-rating level to the training data by gradually applying the de-rating level to the training data by non-linearly increasing the application of the de-rating level to the second portion of the training data from the boundary outwardly from the selected closed shape in accordance with a logistic function.

15. The deep learning network training station according to claim 12, wherein:
the third input of the training station receives the de-emphasis data representative of a de-rating slope to be applied to the second portion of the training data; and
the processor is operable to execute the training station logic to apply the de-rating level to the training data by linearly increasing the application of the de-rating level to the second portion of the training data from the boundary outwardly from the selected closed shape in accordance with the de-rating slope.

16. The deep learning network training station according to claim 12, wherein:
the third input of the training station receives the de-emphasis data representative of parameters of the logistic function to be applied to the second portion of the training data; and
the processor is operable to execute the training station logic to apply the de-rating level to the training data by non-linearly increasing the application of the de-rating level to the second portion of the training data from the boundary outwardly from the selected closed shape in accordance with the logistic function using the parameters.

17. The deep learning network training station according to claim 12, wherein:
the third input of the training station receives darkening de-emphasis data, the darkening de-emphasis data being representative of a darkening de-rating level to be applied to the second portion of the training data; and
the processor is operable to execute the training station logic to apply the darkening de-rating level to form the soft-emphasized training data by an increasing application of the darkening de-rating level to pixels of the training image in the second portion of the training data from the boundary outwardly from the selected closed shape thereby gradually blending the pixels of the training image in the second portion of the training from a non-darkened condition at the boundary between the first and second portions to a darkened condition outwardly from the selected closed shape in accordance with the darkening de-rating level.

18. The deep learning network training station according to claim 12, wherein:
the third input of the training station receives blurring de-emphasis data, the blurring de-emphasis data being representative of a blurring de-rating level to be applied to the second portion of the training data; and
the processor is operable to execute the training station logic to apply the blurring de-rating level to form the soft-emphasized training data by an increasing application of the blurring de-rating level to pixels of the training image in the second portion of the training data from the boundary outwardly from the selected closed shape thereby gradually blending the pixels of the training image in the second portion of the training from a non-blurred condition at the boundary between the first and second portions to a blurred condition outwardly from the selected closed shape in accordance with the blurring de-rating level.

19. The deep learning network training station according to claim 12, wherein:
the third input of the training station receives noise de-emphasis data, the noise de-emphasis data being representative of a noise de-rating level to be applied to the second portion of the training data; and
the processor is operable to execute the training station logic to apply the noise de-rating level to form the soft-emphasized training data by an increasing application of the noise de-rating level to pixels of the training image in the second portion of the training data from the boundary outwardly from the selected closed shape thereby gradually blending the pixels of the training image in the second portion of the training from an added noise free condition at the boundary between the first and second portions to a noise added condition outwardly from the selected closed shape in accordance with the noise de-rating level.

20. The deep learning network training station according to claim 12, wherein:
the third input of the training station receives one or more of darkening de-emphasis data, blurring de-emphasis data, and/or noise de-emphasis data, the darkening de-emphasis data being representative of a darkening de-rating level to be applied to the second portion of the training data, the blurring de-emphasis data being representative of a blurring de-rating level to be applied to the second portion of the training data, and the noise de-emphasis data being representative of a noise de-rating level to be applied to the second portion of the training data; and
the processor is operable to execute the training station logic to apply the one or more of the darkening de-rating level, the blurring de-rating level, and/or the noise de-rating level to form the soft-emphasized training data by an increasing application of the darkening, blurring and/or noise de-rating level to pixels of the training image in the second portion of the training data from the boundary outwardly from the selected closed shape thereby gradually blending the pixels of the training image in the second portion of the training from a darkening, blurring and/or noise free condition at the boundary between the first and second portions to a darkening, blurring and/or noise added condition outwardly from the selected closed shape in accordance with the noise de-rating level.

21. The deep learning network training station according to claim 12, wherein:
the second input of the training station receives isolation data representative of a selected closed geometric shape segregating the training data into a first portion within a boundary defined by the closed geometric shape and a second portion outside of the boundary.

22. The deep learning network training station according to claim 12, wherein:
the second input of the training station receives isolation data representative of a selected closed user-defined free-form lasso shape segregating the training data into a first portion within a boundary defined by the closed user-defined free-form lasso shape and a second portion outside of the boundary.
